(19) United States
(12) Patent Application Publication
(10) Pub. No.: US 2026/0052613 A1
(43) Pub. Date: Feb. 19, 2026

(54) MOTION SENSOR WITH SELF-ADAPTIVE ADJUSTMENT FUNCTION AND SELF-ADAPTIVE ADJUSTMENT METHOD THEREOF

(71) Applicant: Xiamen PVTECH Co., Ltd., Xiamen (CN)

(72) Inventors: TENG LIN, Xiamen (CN); ZHIRONG LIN, Xiamen (CN); FUXING LU, Xiamen (CN)

(73) Assignee: Xiamen PVTECH Co., Ltd., Xiamen (CN)

(21) Appl. No.: 19/303,314

(22) Filed: Aug. 18, 2025

(30) Foreign Application Priority Data
Aug. 19, 2024 (CN) 202411139095.5

(51) Int. Cl. H05B 47/13; F21V 23/04

(52) U.S. Cl. CPC H05B 47/13; F21V 23/0471

(57) ABSTRACT

A motion sensor with self-adaptive adjustment function includes a sensing module, a processing module and a communication module. The sensing module generates a sensing signal. The processing module is connected to the sensing module, and calculates the duration of the sensing signal. The communication module is connected to the processing module. When the processing module is in a preset state and the duration of the sensing signal is greater than or equal to a target threshold value, the processing module generates a control signal and transmits the control signal to a target device via the communication module.

### BACKGROUND OF THE INVENTION

### 1. Field of the Invention

The present invention relates to a motion sensor, in particular to a motion sensor with self-adaptive adjustment function. The present invention further relates to the self-adaptive adjustment method of the motion sensor.

### 2. Description of the Prior Art

The motion sensor can generate a sensing signal upon detecting moving objects to activate target devices (such as lighting devices, fans, or other similar devices). As a result, motion sensors have extremely broad applications. However, currently available motion sensors (e.g., microwave sensors, infrared motion sensors, etc.) may generate false alarms due to self-excitation or other external interference. Consequently, target devices controlled by such motion sensors may be erroneously turned on and off, leading to abnormal operation. For instance, lighting devices installed in garages may frequently turn on and off due to false alarms from microwave sensors, causing other lighting devices in the same group to also cycle unnecessarily.

### SUMMARY OF THE INVENTION

One embodiment of the present invention provides a motion sensor with self-adaptive adjustment function, which includes a sensing module, a processing module and a communication module. The sensing module generates a sensing signal. The processing module is connected to the sensing module, and calculates the duration of the sensing signal. The communication module is connected to the processing module. When the processing module is in a preset state and the duration of the sensing signal is greater than or equal to a target threshold value, the processing module generates a control signal and transmits the control signal to a target device via the communication module.

Another embodiment of the present invention provides a self-adaptive adjustment method for a motion sensor, which includes the following steps: generating a sensing signal via a sensing module; calculating the duration of the sensing signal by a processing module; generating a control signal by the processing module when the processing module is in a preset state and the duration of the sensing signal is greater than or equal to a target threshold value; and transmitting the control signal to a target device by a communication module.

Further scope of applicability of the present application will become more apparent from the detailed description given hereinafter. However, it should be understood that the detailed description and specific examples, while indicating exemplary embodiments of the present invention, are given by way of illustration only, since various changes and modifications within the spirit and scope of the present invention will become apparent to those skilled in the art from this detailed description.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

The present invention will become more fully understood from the detailed description given herein below and the accompanying drawings which are given by way of illustration only, and thus are not limitative of the present invention and wherein:

FIG. 1 is a block diagram of a circuit structure of a motion sensor with self-adaptive adjustment function in accordance with a first embodiment of the present invention.

FIG. 2 is a schematic view of an operational state of the motion sensor with self-adaptive adjustment function in accordance with the first embodiment of the present invention.

FIG. 3 is a first schematic view of a sensing signal of the motion sensor with self-adaptive adjustment function in accordance with the first embodiment of the present invention.

FIG. 4 is a second schematic view of the sensing signal of the motion sensor with self-adaptive adjustment function in accordance with the first embodiment of the present invention.

FIG. 5 is a flow chart of a self-adaptive adjustment method for a motion sensor in accordance with a first embodiment of the present invention.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing. It should be understood that, when it is described that an element is “coupled” or “connected” to another element, the element may be “directly coupled” or “directly connected” to the other element or “coupled” or “connected” to the other element through a third element. In contrast, it should be understood that, when it is described that an element is “directly coupled” or “directly connected” to another element, there are no intervening elements.

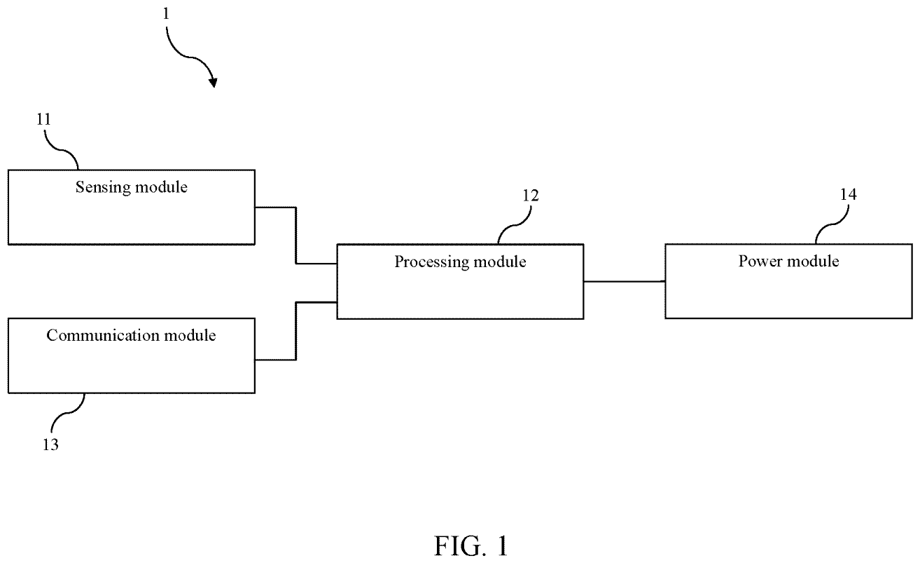

Please refer to FIG. 1, which is a block diagram of a circuit structure of a motion sensor with self-adaptive adjustment function in accordance with a first embodiment of the present invention. As shown in FIG. 1, the motion sensor 1 includes a sensing module 11, a processing module 12, a communication module 13, and a power module 14.

The processing module 12 is connected to the sensing module 11. In one embodiment, the processing module 12 may be a microcontroller unit (MCU). In another embodiment, the processing module 12 may also be a central-processing unit (CPU), application-specific integrated circuit (ASIC), field-programmable gate array (FPGA), or other similar components. In one embodiment, the sensing module 11 may be a microwave sensor. In another embodiment, the sensing module 11 may also be an infrared motion (PIR) sensor.

The communication module 13 is connected to the processing module 14. In one embodiment, the communication module 13 may be a Bluetooth™ module. In another embodiment, the communication module 13 may also be a ZigBee™ module, WiFi™ module, or other similar components.

The power module 14 is connected to the processing module 14. In one embodiment, the power module 14 may be a rechargeable battery, such as a lithium-ion battery, nickel-cadmium battery, or nickel-metal hydride battery. In another embodiment, the power module 14 may be a primary battery, such as a carbon-zinc battery or alkaline battery.

The embodiment just exemplifies the present invention and is not intended to limit the scope of the present invention; any equivalent modification and variation according to the spirit of the present invention is to be also included within the scope of the following claims and their equivalents.

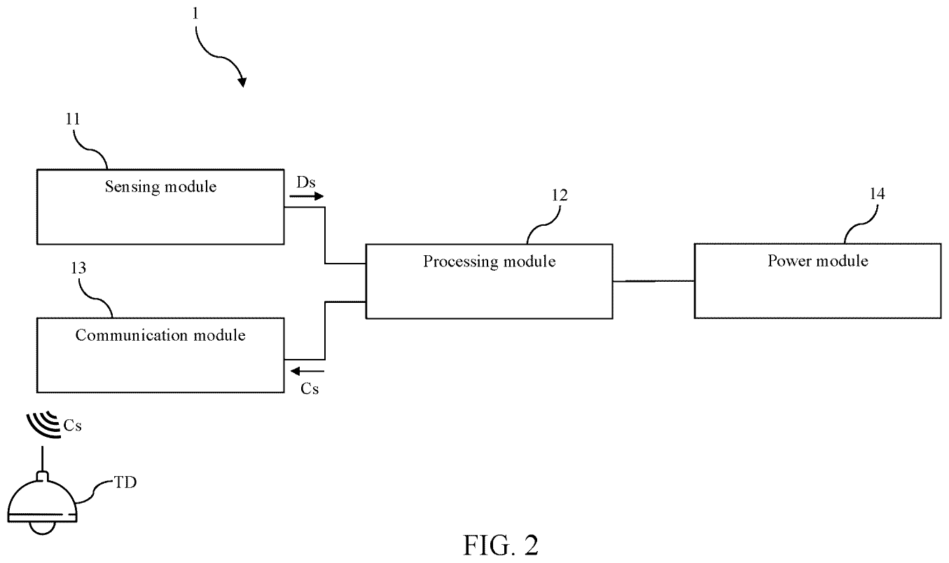

Please refer to FIG. 2, which is a schematic view of an operational state of the motion sensor with self-adaptive adjustment function in accordance with the first embodiment of the present invention. As shown in FIG. 2, when the sensing module 11 detects a moving object MB (such as a person or vehicle), the sensing module 11 generates a sensing signal Ds. The initial value of the sensing signal Ds generated by the sensing module 11 is a preset standard value (which may be 500 ms, 600 ms, 700 ms, etc.,) and can be adjusted according to actual requirements. Since the moving object MB passes through the detection range of the sensing module 11, the sensing module 11 is continuously triggered. Therefore, the duration of the sensing signal Ds will be greater than the preset standard value. If the moving object MB stops along its path through the sensing module 11's detection range, the sensing module 11 may generate multiple sensing signals Ds, but the duration of these sensing signals Ds will all be greater than or at least equal to the preset standard value.

Before executing the self-adaptive adjustment function, the processing module 12 is in a preset state. The processing module 12 calculates the duration of the sensing signal Ds. When the processing module 12 detects the rising edge of the sensing signal Ds, the processing module 12 starts timing. When the processing module 12 detects the falling edge of the sensing signal Ds, the processing module 12 stops timing. The processing module 12 compares the duration of the sensing signal Ds with a target threshold value, where in the preset state this target threshold value may equal the preset standard value. When the processing module 12 is in the preset state and the duration of the sensing signal Ds is greater than or equal to the target threshold value, the processing module 12 generates a control signal Cs and transmits the control signal Cs to a target device TD via the communication module 13. The target device TD may include but is not limited to lighting devices or various electrical appliances (such as fans, air conditioners, televisions, etc.).

The sensing module 11 may generate sensing signals Ds due to self-excitation or other external interference (such as from fans). However, since the sensing module 11 does not detect any moving object MB, the sensing module 11 is not continuously triggered. Therefore, the duration of the sensing signal Ds will be equal to the preset standard value. When the processing module 12 continuously receives multiple sensing signals Ds, the processing module 12 calculates the number of sensing signals Ds and the duration of each sensing signal Ds. The processing module 12 executes the self-adaptive adjustment function when the number of sensing signals Ds is greater than or equal to a preset number and the duration of each sensing signal Ds is equal to the preset standard value. At this time, the processing module 12 transitions from the initial state to a self-adaptive adjustment state. The preset number may be but is not limited to 10. In another embodiment, the preset number may also be 5, 8, or 15, and can be adjusted according to actual requirements. After entering the self-adaptive adjustment state, the processing module 12 increases the target threshold value to reduce the sensitivity of the sensing module 11. The processing module 12 may increase the target threshold value so that the target threshold value can be equal to the product of the preset standard value and a self-adaptive adjustment coefficient, as shown in Equation (1) given below:

Th=K×Td (1)

In Equation (1), Th stands for the target threshold value, K stands for the self-adaptive adjustment coefficient; Td stands for the preset standard value. The self-adaptive adjustment coefficient is greater than 1 but less than 2. In this embodiment, the self-adaptive adjustment coefficient may be 1.2. In another embodiment, the self-adaptive adjustment coefficient may be 1.3, 1.4, 1.5, or 1.8, and can be adjusted according to actual requirements. If the processing module 12 detects that the duration of the sensing signal Ds is greater than the preset standard value, the processing module 12 resets the count. In yet another embodiment, the self-adaptive adjustment coefficient may also be greater than 2, such as 2.5, 2.8, or 3, and can be adjusted according to actual requirements.

Thus, through the self-adaptive adjustment function based on the duration of the sensing signal Ds, the processing module 12 can promptly increase the target threshold value when the sensing module 11 generates false alarms due to self-excitation or other external interference, thereby reducing the sensitivity thereof. This ensures that the processing module 12 generates the control signal Cs to control the target device TD only when the sensing module 11 truly detects a moving object MB, allowing the target device TD to operate normally. Therefore, the accuracy of the motion sensor 1 can be significantly improved.

As can be seen from the above description, in this embodiment, when the processing module 12 is in the self-adaptive adjustment state, the processing module 12 increases the target threshold value such that the target threshold value can be equal to the product of the preset standard value and the self-adaptive adjustment coefficient. Through this design based on the self-adaptive adjustment coefficient, the user can adjust the self-adaptive adjustment coefficient according to the characteristics of different sensing modules 11, enabling the self-adaptive adjustment function to effectively prevent false alarms from the sensing module 11 and improve the accuracy of the motion sensor 1. Therefore, the motion sensor 1 can be more flexible in use and more comprehensive in application.

Furthermore, in this embodiment, the self-adaptive adjustment function based on the duration of the sensing signal Ds can be effectively implemented using only the timing and counting functions of the processing module 12, without requiring additional electronic components or complex software. Moreover, this self-adaptive adjustment function reliably improves the accuracy of the motion sensor 1. Consequently, this function does not significantly increase the cost of the motion sensor 1, such that the motion sensor 1 can meet requirements of various applications.

Additionally, in this embodiment, the self-adaptive adjustment function based on the duration of the sensing signal Ds effectively optimizes the performance of the motion sensor 1. Therefore, the motion sensor 1 can be widely applied in IoT systems or other smart systems (such as smart garage systems and smart home systems) while achieving high accuracy. Thus, the motion sensor 1 is well-aligned with future development trends.

Moreover, in this embodiment, the motion sensor 1 features a simple design and can implement the self-adaptive adjustment function without requiring additional electronic components or complex software, thereby achieving desired effects without significantly increasing costs. As such, the motion sensor 1 offers high practicality and reliably meets actual requirements.

The embodiment just exemplifies the present invention and is not intended to limit the scope of the present invention; any equivalent modification and variation according to the spirit of the present invention is to be also included within the scope of the following claims and their equivalents.

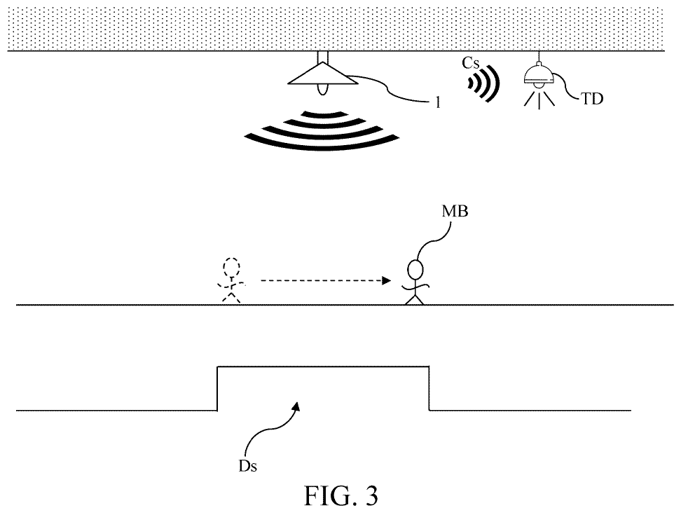

Please refer to FIG. 3, which is a first schematic view of a sensing signal of the motion sensor with self-adaptive adjustment function in accordance with the first embodiment of the present invention. Please also refer to FIG. 1 and FIG. 2. As shown in FIG. 3, when the sensing module 11 of the motion sensor 1 detects the moving object MB, the sensing module 11 generates the sensing signal Ds. Since the moving object MB passes through the detection range of the sensing module 11, the sensing module 11 is continuously triggered, causing the duration of the sensing signal Ds to exceed the preset standard value. The processing module 12 starts timing when detecting the rising edge of the sensing signal Ds and stops timing when detecting the falling edge. The processing module 12 compares the duration of the sensing signal Ds with the target threshold value, which in the preset state may equal the preset standard value. When the processing module 12 is in the preset state and the duration of the sensing signal Ds is greater than or equal to the target threshold value, the processing module 12 generates the control signal Cs and transmits the control signal Cs to the target device TD via the communication module 13 in order to activate the target device TD.

The embodiment just exemplifies the present invention and is not intended to limit the scope of the present invention; any equivalent modification and variation according to the spirit of the present invention is to be also included within the scope of the following claims and their equivalents.

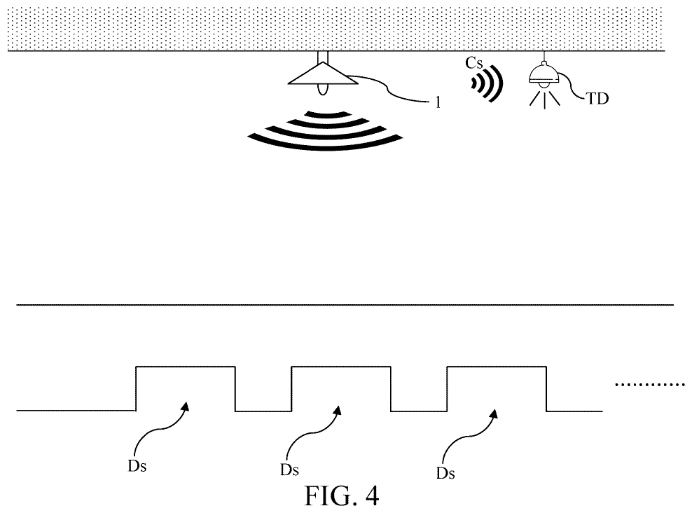

Please refer to FIG. 4, which is a second schematic view of the sensing signal of the motion sensor with self-adaptive adjustment function in accordance with the first embodiment of the present invention. Please also refer to FIG. 1 and FIG. 2. As shown in FIG. 4, the sensing module 11 may generate sensing signals Ds due to self-excitation or other external interference. However, since the sensing module 11 does not detect any moving object MB, the sensing module 11 is not continuously triggered. In this case, the duration of the sensing signal Ds is equal to the preset standard value. When the processing module 12 continuously receives multiple sensing signals Ds, the processing module 12 calculates the number of these sensing signals Ds and the duration of each sensing signal Ds. The processing module 12 executes the self-adaptive adjustment function when the number of sensing signals Ds reaches or exceeds the preset number and all durations are equal to the preset standard value. At this point, the processing module 12 transitions from the initial state to the self-adaptive adjustment state and increases the target threshold value to reduce the sensitivity of the sensing module 11. Although the processing module 12 may still generate the control signal Cs to activate the target device TD under this condition, when the sensing module 11 is triggered again by self-excitation or other interference, the processing module 12 will not generate the control signal Cs to activate the target device TD due to the reduced sensitivity.

As demonstrated above, through this self-adaptive adjustment function based on the duration of sensing signals Ds, the processing module 12 can promptly increase the target threshold value when the sensing module 11 generates false alarms due to self-excitation or other interference, thereby reducing the sensitivity thereof. This ensures the processing module 12 generates the control signal Cs to control the target device TD only when the sensing module 11 genuinely detects a moving object MB, allowing normal operation of the target device TD. Consequently, the accuracy of the motion sensor 1 is significantly improved.

The embodiment just exemplifies the present invention and is not intended to limit the scope of the present invention; any equivalent modification and variation according to the spirit of the present invention is to be also included within the scope of the following claims and their equivalents.

It is worthy to point out that currently available motion sensors (e.g., microwave sensors, infrared motion sensors, etc.) may generate false alarms due to self-excitation (or other external interference). Consequently, target devices controlled by such motion sensors may be erroneously turned on and off. By contrast, according to one embodiment of the present invention, the motion sensor includes a sensing module, a processing module, and a communication module. The sensing module generates a sensing signal. The processing module is connected to the sensing module and calculates the duration of the sensing signal. The communication module is connected to the processing module. When the processing module is in a preset state and the duration of the sensing signal is greater than or equal to a target threshold value, the processing module generates a control signal and transmits the control signal to a target device via the communication module. When the processing module continuously receives multiple sensing signals, it calculates the number of the multiple sensing signals and the duration of each sensing signal. The processing module enters a self-adaptive adjustment state and increases the target threshold value when the number of the multiple sensing signals is greater than or equal to a preset number and the duration of each sensing signal equals a preset standard value. Through the self-adaptive adjustment function based on the duration of the sensing signal, the processing module can promptly raise the target threshold value when the sensing module generates false alarms due to self-excitation or other external interference, thereby reducing its sensitivity. As a result, the processing module ensures that the control signal is generated only when the sensing module truly detects a moving object, allowing the target device to operate normally. Thus, the accuracy of the motion sensor can be significantly improved.

Also, according to one embodiment of the present invention, when the processing module is in the self-adaptive adjustment state, it increases the target threshold value such that the target threshold value equals the product of the preset standard value and a self-adaptive adjustment coefficient. Through the design based on the self-adaptive adjustment coefficient, users can adjust the coefficient according to the characteristics of different sensing modules, enabling the self-adaptive adjustment function to effectively prevent false alarms and enhance the accuracy of the motion sensor. Therefore, the motion sensor offers greater flexibility in use and broader applicability.

Further, according to one embodiment of the present invention, the self-adaptive adjustment function based on the duration of the sensing signal can be effectively implemented using only the timing and counting functions of the processing module, without requiring additional electronic components or complex software. Furthermore, this self-adaptive adjustment function reliably improves the accuracy of the motion sensor. Consequently, this function does not significantly increase the cost of the motion sensor, allowing it to meet the requirements of various applications.

Moreover, according to one embodiment of the present invention, the self-adaptive adjustment function based on the duration of the sensing signal effectively optimizes the performance of the motion sensor. As a result, the motion sensor can be widely applied in IoT systems or other smart systems (such as smart garage systems, smart home systems, etc.) while achieving high accuracy. Thus, the motion sensor is well-aligned with future development trends.

Furthermore, according to one embodiment of the present invention, the motion sensor has a simple design and does not require additional electronic components or complex software to implement the self-adaptive adjustment function. Therefore, it achieves the desired effects without significantly increasing costs. As such, the motion sensor offers high practicality and reliably meets real-world application needs. As set forth above, the motion sensor with self-adaptive adjustment function according to the embodiments of the present invention can definitely achieve great technical effects.

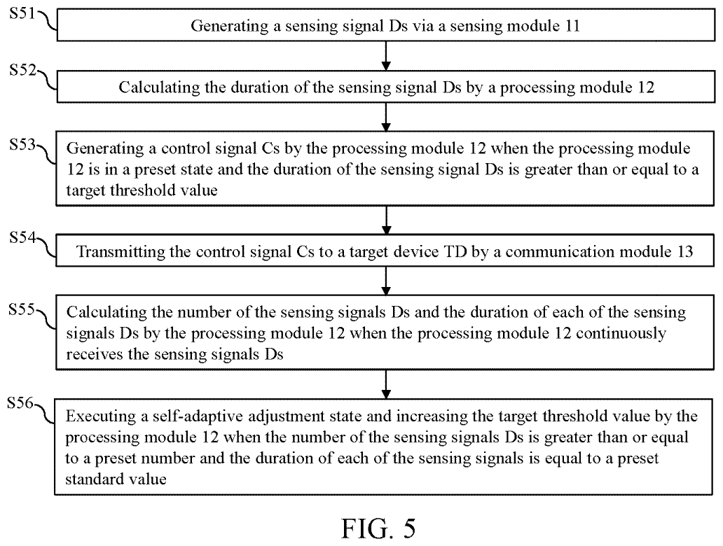

Please refer to FIG. 5, which is a flow chart of a self-adaptive adjustment method for a motion sensor in accordance with a first embodiment of the present invention. As shown in FIG. 5, the self-adaptive adjustment method of this embodiment includes the following steps:

Step S51: generating a sensing signal Ds via a sensing module 11.

Step S52: calculating the duration of the sensing signal Ds by a processing module 12.

Step S53: generating a control signal Cs by the processing module 12 when the processing module 12 is in a preset state and the duration of the sensing signal Ds is greater than or equal to a target threshold value. When the processing module 12 is in the preset state, the target threshold value is equal to the preset standard value.

Step S54: transmitting the control signal Cs to a target device TD by a communication module 13.

Step S55: calculating the number of the sensing signals Ds and the duration of each of the sensing signals Ds by the processing module 12 when the processing module 12 continuously receives the sensing signals Ds.

Step S56: executing a self-adaptive adjustment state and increasing the target threshold value by the processing module 12 when the number of the sensing signals Ds is greater than or equal to a preset number and the duration of each of the sensing signals is equal to a preset standard value. When the processing module 12 is in the self-adaptive adjustment state, the processing module 12 increases the target threshold value such that the target threshold value can be equal to the product of the preset standard value and the self-adaptive adjustment coefficient. The self-adaptive adjustment coefficient is greater than 1 but less than 2. The self-adaptive adjustment coefficient may also be greater than 2 and can be adjusted according to actual requirements.

The embodiment just exemplifies the present invention and is not intended to limit the scope of the present invention; any equivalent modification and variation according to the spirit of the present invention is to be also included within the scope of the following claims and their equivalents.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

To sum up, according to one embodiment of the present invention, the motion sensor includes a sensing module, a processing module, and a communication module. The sensing module generates a sensing signal. The processing module is connected to the sensing module and calculates the duration of the sensing signal. The communication module is connected to the processing module. When the processing module is in a preset state and the duration of the sensing signal is greater than or equal to a target threshold value, the processing module generates a control signal and transmits the control signal to a target device via the communication module. When the processing module continuously receives multiple sensing signals, it calculates the number of the multiple sensing signals and the duration of each sensing signal. The processing module enters a self-adaptive adjustment state and increases the target threshold value when the number of the multiple sensing signals is greater than or equal to a preset number and the duration of each sensing signal equals a preset standard value. Through the self-adaptive adjustment function based on the duration of the sensing signal, the processing module can promptly raise the target threshold value when the sensing module generates false alarms due to self-excitation or other external interference, thereby reducing its sensitivity. As a result, the processing module ensures that the control signal is generated only when the sensing module truly detects a moving object, allowing the target device to operate normally. Thus, the accuracy of the motion sensor can be significantly improved.

Also, according to one embodiment of the present invention, when the processing module is in the self-adaptive adjustment state, it increases the target threshold value such that the target threshold value equals the product of the preset standard value and a self-adaptive adjustment coefficient. Through the design based on the self-adaptive adjustment coefficient, users can adjust the coefficient according to the characteristics of different sensing modules, enabling the self-adaptive adjustment function to effectively prevent false alarms and enhance the accuracy of the motion sensor. Therefore, the motion sensor offers greater flexibility in use and broader applicability.

Further, according to one embodiment of the present invention, the self-adaptive adjustment function based on the duration of the sensing signal can be effectively implemented using only the timing and counting functions of the processing module, without requiring additional electronic components or complex software. Furthermore, this self-adaptive adjustment function reliably improves the accuracy of the motion sensor. Consequently, this function does not significantly increase the cost of the motion sensor, allowing it to meet the requirements of various applications.

Moreover, according to one embodiment of the present invention, the self-adaptive adjustment function based on the duration of the sensing signal effectively optimizes the performance of the motion sensor. As a result, the motion sensor can be widely applied in IoT systems or other smart systems (such as smart garage systems, smart home systems, etc.) while achieving high accuracy. Thus, the motion sensor is well-aligned with future development trends.

Furthermore, according to one embodiment of the present invention, the motion sensor has a simple design and does not require additional electronic components or complex software to implement the self-adaptive adjustment function. Therefore, it achieves the desired effects without significantly increasing costs. As such, the motion sensor offers high practicality and reliably meets real-world application needs.

It will be apparent to those skilled in the art that various modifications and variations can be made to the disclosed embodiments. It is intended that the specification and examples be considered as exemplary only, with a true scope of the present invention being indicated by the following claims and their equivalents.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A motion sensor with self-adaptive adjustment function, comprising:
a sensing module configured to generate a sensing signal;
a processing module connected to the sensing module, and configured to calculate a duration of the sensing signal; and
a communication module connected to the processing module;
wherein when the processing module is in a preset state and the duration of the sensing signal is greater than or equal to a target threshold value, the processing module is configured to generate a control signal and transmit the control signal to a target device via the communication module.

2. The motion sensor with self-adaptive adjustment function as claimed in claim 1, wherein when the processing module continuously receives the sensing signals, the processing module is configured to calculate a number of the sensing signals and the duration of each of the sensing signals, wherein the processing module is configured to enter a self-adaptive adjustment state and increase the target threshold value when the number of the sensing signals is greater than or equal to a preset number and the duration of each of the sensing signals is equal to a preset standard value.

3. The motion sensor with self-adaptive adjustment function as claimed in claim 2, wherein when the processing module is in the preset state, the target threshold value is equal to the preset standard value.

4. The motion sensor with self-adaptive adjustment function as claimed in claim 2, wherein when the processing module is in the self-adaptive adjustment state, the processing module is configured to increase the target threshold value, whereby the target threshold value is equal to a product of the preset standard value and a self-adaptive adjustment coefficient.

5. The motion sensor with self-adaptive adjustment function as claimed in claim 4, wherein the sensing module is a microwave sensor or an infrared motion sensor.

6. A self-adaptive adjustment method for a motion sensor, comprising:
generating a sensing signal via a sensing module;
calculating a duration of the sensing signal by a processing module;
generating a control signal by the processing module when the processing module is in a preset state and the duration of the sensing signal is greater than or equal to a target threshold value; and
transmitting the control signal to a target device by a communication module.

7. The self-adaptive adjustment method for the motion sensor as claimed in claim 6, further comprising:
calculating a number of the sensing signals and the duration of each of the sensing signals by the processing module when the processing module continuously receives the sensing signals; and
executing a self-adaptive adjustment state and increasing the target threshold value by the processing module when the number of the sensing signals is greater than or equal to a preset number and the duration of each of the sensing signals is equal to a preset standard value.

8. The self-adaptive adjustment method for the motion sensor as claimed in claim 7, wherein when the processing module is in the preset state, the target threshold value is equal to the preset standard value.

9. The self-adaptive adjustment method for the motion sensor as claimed in claim 7, wherein when the processing module is in the self-adaptive adjustment state, the processing module is configured to increase the target threshold value, whereby the target threshold value is equal to a product of the preset standard value and a self-adaptive adjustment coefficient.

10. The self-adaptive adjustment method for the motion sensor as claimed in claim 9, wherein the sensing module is a microwave sensor or an infrared motion sensor.
